(19) United States
(12) Patent Application Publication
(10) Pub. No.: US 2013/0052384 A1
(43) Pub. Date: Feb. 28, 2013

(54) COPOLYAMIDE COMPOSITIONS DERIVED FROM VEGETABLE OIL

(71) Applicants: JOHN GAVENONIS, Wilmington, DE (US); Anna Kutty Mathew, Kingston (CA)

(72) Inventors: JOHN GAVENONIS, Wilmington, DE (US); Anna Kutty Mathew, Kingston (CA)

(73) Assignee: E I DU PONT DE NEMOURS AND COMPANY, Wilmington, DE (US)

(21) Appl. No.: 13/596,120

(22) Filed: Aug. 28, 2012

Related U.S. Application Data
(60) Provisional application No. 61/528,429, filed on Aug. 29, 2011.

(51) Int. Cl. C08G 69/26; B32B 1/08; C08L 77/06

(52) U.S. Cl. 428/36.9; 528/339; 524/607

(57) ABSTRACT

Disclosed is a copolyamide including 8 to 92 mole percent repeat units of the formula

—C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12; thermoplastic compositions including the copolyamide; and molded and extruded articles prepared from the thermoplastic compositions.

### CROSS-REFERENCE TO RELATED APPLICATIONS

This application claims priority of Application No. 61/528,429, filed Aug. 29, 2011.

### FIELD OF INVENTION

The present invention relates to the field of polyamide compositions derived from vegetable oils and having improved salt resistance.

### BACKGROUND OF INVENTION

Polymeric materials, including thermoplastics and thermosets, are used extensively in automotive vehicles and for other purposes. They are light and relatively easy to fashion into complex parts, and are therefore preferred instead of metals in many instances. However a problem with some polymers is salt stress (induced) corrosion cracking (SSCC), where a part under stress undergoes accelerated corrosion when under stress and in contact with inorganic salts. This often results in cracking and premature failure of the part. Parts also may have to exhibit unusually high durability and toughness under use conditions. For instance vehicular wheels must maintain high toughness under a variety of environmental conditions to avoid catastrophic failure.

Polyamides such as polyamide 6,6, polyamide 6, polyamide 6,10 and polyamide 6,12 have been made into and used as vehicular parts and other types of parts. While it has been reported that polyamides 6,10 and 6,12 are more resistant to SSCC (see for instance Japanese Patent 3271325B2), all of these polyamides are prone to SSCC in such uses, because for instance, various sections of vehicles and their components are sometimes exposed to salts, for example salts such as sodium chloride or calcium chloride used to melt snow and ice in colder climates. Corrosion of metallic parts such as fittings and frame components made from steel and various iron based alloys in contact with water and road salts can also lead to formation of salts. These salts, in turn, can attack the polyamide parts making them susceptible to SSCC. Thus polyamide compositions with better resistance to SSCC are desired.

U.S. Pat. No. 4,076,664 discloses a terpolyamide resin that has favorable resistance to zinc chloride.

European patent application 0272503 discloses a molding polyamide resin comprising poly(m-xylylenesebacamide) (PA MXD10) and a crystalline polyamide having a melting point about 20-30° C. higher than that of PA MXD10.

US 2005/0234180 discloses a resin molded article having an excellent snow melting salt resistance, said article comprising 1 to 60% by weight of aromatic polyamide resin.

Furthermore, increasing fossil raw material prices make it desirable to develop engineering polymers from linear, long chain dicarboxylic acids from renewable feedstocks. As such, there is a demand for renewable bio-based polymers having similar or better performance characteristics than petrochemical-based polymers. As example, renewable nylon materials such as PA 610 are based on ricinoleic acid derived sebacic acid (C10). However, ricinoleic acid production requires the processing castor beans and involves the handling of highly allergenic material and highly toxic ricin. Moreover, the production of sebacic acid is burdened with high energy consumption, a large amount of salt by product and other byproducts:

WO 2010/068904 discloses a method to produce renewable alkanes from biomass based triglycerides in high yield and selectivity and their fermentation to renewable diacids. Such naturally occurring triglycerides, also referred to as oils and fats, are composed of a variety of fatty acid chain lengths specific to the type of fat and oil. Most abundant amongst vegetable oils are triglycerides based on C12, C14, C16 and C18 fatty acids. Several vegetable oils are rich in C16 and C18 fatty esters including soybean oil, palm oil, sunflower oil, olive oil, cotton seed oil and corn oil (Ullmann's Ecyclopedia of Technical Chemistry, A. Thomas: “Fats and Fatty Oils” (2005 Wiley-VCH Verlag GmbH & Co. KGaA, Weinheim, electronic version, 10.1002114356007.a10 173). As such, dioic acid streams based on the oxidative fermentation of renewable alkanes derived from such oils, being rich in C16 and C18 dioic acids, may be useful in formation of economically attractive polymers.

Thus, desired are copolymers that make use of renewable C16 and C18 dioic acids. Also desired are polyamide copolymers that have favorable properties for injection molding and extrusion and provide resistance to salt stress (induced) corrosion cracking.

### SUMMARY OF INVENTION

Disclosed is a copolyamide consisting essentially of 8 to 92 mole percent repeat units of the formula

—C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12.

Further disclosed is a thermoplastic composition comprising
A) a copolyamide consisting essentially of 8 to 92 mole percent repeat units of the formula

—C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12; and at least one component selected from the group consisting of:
B) 0 to 60 wt % of at least one reinforcing agent;
C) 0 to 30 wt % of at least one polymeric toughener;
D) 0 to 10 weight percent of a functional additive;
   wherein the weight percent of A), B), C), and D) are based on the total weight of the thermoplastic composition, and at least one component of the group B), C) and D) is present in at least 0.1 weight percent.

Another embodiment is a molded article prepared from the thermoplastic composition disclosed above.

Another embodiment is a tubing comprising:
(A) a copolyamide consisting essentially of 8 to 92 mole percent repeat units of the formula

—C(O)(CH₂)₁₄C(O)NH(CH₂)ₙNH— (I); and

8 to 92 mole percent repeat units of the formula

—C(O)(CH₂)₁₆C(O)NH(CH₂)ₙNH— (II);

wherein n is an integer selected from 4, 6, 10 or 12;
(B) 0 to 30 weight percent of at least one polymeric toughener;
(D) 0 to 10 weight percent thermal stabilizer; and
(E) 0 to 20 weight percent of plasticizer; and
wherein the weight percent of (A), (B), and (O) and (E) are based on the total weight of the thermoplastic composition.

Another embodiment is the use of a polyamide or copolyamide consisting essentially of repeat units selected from the group consisting of formulas

C(O)(CH₂)₁₄C(O)NH(CH₂)ₙNH— (I)

—C(O)(CH₂)₁₆C(O)NH(CH₂)ₙNH— (II);

and mixtures of (I) and (II); wherein n is an integer selected from 4, 6, 10 and 12; to provide salt resistance in injection molded thermoplastic articles.

### BRIEF DESCRIPTION OF FIGURES

FIG. 1 shows a dynamic mechanical analysis of a crystalline copolymer.

### DETAILED DESCRIPTION

Herein melting points are as determined with differential scanning calorimetry (DSC) at a scan rate of 10° C./min in the first heating scan, wherein the melting point is taken at the maximum of the endothermic peak, and the heat of fusion in Joules/gram (J/g) is the area within the endothermic peak.

Herein freezing points are as determined with DSC in the cooling cycle at a scan rate of 10° C./min carried out after the first heating cycle as per ASTM D3418.

Herein the term delta melting point minus freezing point (MP-FP, in ° C.) is the difference between the melting point and freezing point of a particular polymer or copolymer, wherein the melting point and freezing point are determined as disclosed above. The term delta MP-FP is one measure of the crystallinity of polymer or copolymer and, in part, determines the crystallization kinetics of the polymer or copolymer. A low delta MP-FP typically gives high crystallization rates; and faster cycle times in injected molded parts. A low delta MP-FP typically gives desirable high temperature properties in extrusion processing as well.

Dynamic mechanical analysis (DMA) is used herein for determination of storage modulus (E′) and loss modulus (E″), and glass transition, as a function of temperature. Tan delta is a curve resulting from the loss modulus divided by the storage modulus (E″/E′) as a function of temperature.

Dynamic mechanical analysis is discussed in detail in “Dynamic Mechanical Analysis: A practical Introduction,” Menard K. P., CRC Press (2008) ISBN is 978-1-4200-5312-8. Storage modulus)(E′), loss modulus (E″) curves exhibit specific changes in response to molecular transitions occurring in the polymeric material in response to increasing temperature. A key transition is called glass transition. It characterizes a temperature range over which the amorphous phase of the polymer transitions from glassy to rubbery state, and exhibits large scale molecular motion. Glass transition temperature is thus a specific attribute of a polymeric material and its morphological structure. For the copolyamide compositions disclosed herein, the glass transition occurs over a temperature range of about 20 to about 90° C. The Tan delta curve exhibits a prominent peak in this temperature range. This peak tan delta temperature is defined in the art as the tan delta glass transition temperature, and the height of the peak is a measure of the crystallinity of the polymeric material. A polymeric sample with low or no crystallinity exhibits a tall tan delta peak due to large contribution of the amorphous phase molecular motion, while a sample with high level of crystallinity exhibits a smaller peak because molecules in crystalline phase are not able to exhibit such large scale rubbery motion. Thus, herein the value of tan delta glass transition peak is used as a comparative indicator of level of crystallinity in the copolyamides and melt-blended thermoplastic polyimide compositions.

One embodiment of the invention is a copolyamide consisting essentially of 8 to 92 mole percent repeat units of the formula

—C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12; and
wherein the copolyamide has a DMA tan delta peak value of less than or equal to 0.20, and preferably 0.18, and more preferably 0.15; and a heat of fusion of at least 40 J/g as measured in first heat cycle of DSC. In another embodiment the copolyamide preferably has a Delta T (MP-FP) of less than 40° C., and preferably less than 30° C.

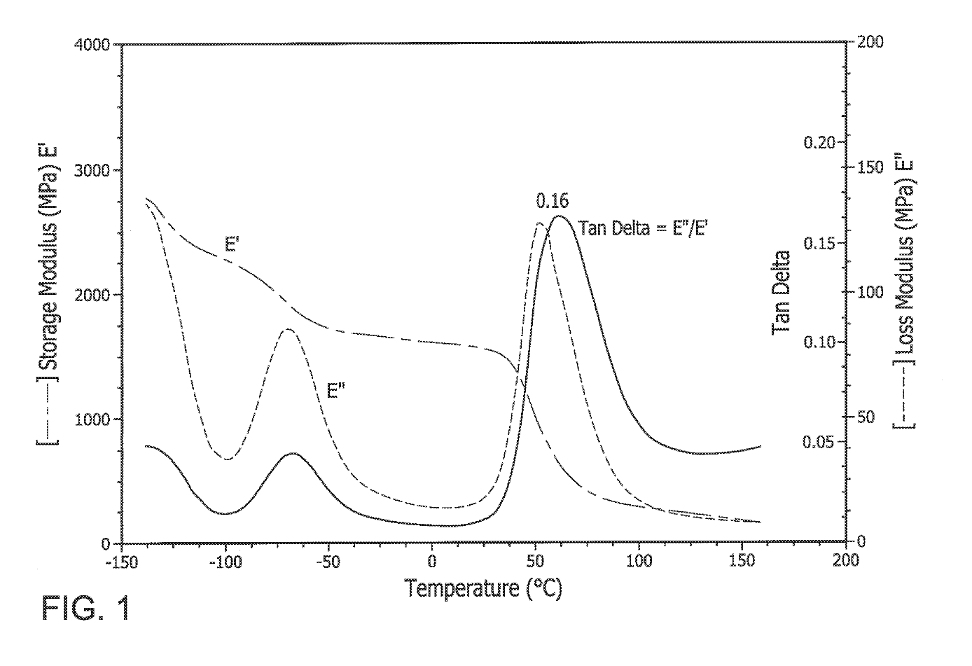

FIG. 1 shows a dynamic mechanical analysis of a crystalline copolymer showing the storage modulus (E′), loss modulus (E″) curves and computed tan delta curve (E″/E′). A higher tan delta peak corresponds to lower crystallinity and conversely, a lower tan delta peak corresponds to higher crystallinity; as discussed in “Thermal Analysis of Polymers,” Sepe M. P. Rapra Review Reports, Vol. 8, No. 11 (1977).

The Copolymers disclosed herein have two or more diamide molecular repeat units. The copolymers are identified by their respective repeat units. The following list exemplifies the abbreviations used to identify monomers and repeat units in the homopolymer and copolymer polyamides (PA) disclosed herein:
TMD 1,4-tetramethylene diamine (or 4 when used in combination with a diacid)
HMD 1,6-hexamethylene diamine (or 6 when used in combination with a diacid)
AA Adipic acid
DMD Decamethylenediamine
4 1,4-diaminobutane
6 [symbol] -Caprolactam
16 hexadecane dioic acid
18 octadecanedioic acid
DDA Decanedioic acid
DDDA Dodecanedioic acid
TMD 1,4-tetramethylene diamine
66 polymer repeat unit formed from HMD and AA
610 polymer repeat unit formed from HMD and DDA
612 polymer repeat unit formed from HMD and DDDA
616 polymer repeat unit formed from HMD and hexadecane dioic acid
618 polymer repeat unit formed from HMD and octadecane dioic acid 6 polymer repeat unit formed from [symbol] -caprolactam
11 polymer repeat unit formed from 11-aminoundecanoic acid
12 polymer repeat unit formed from 12-aminododecanoic acid

Note that in the art the term “6” when used alone designates a polymer repeat unit formed from [symbol] -caprolactam. Alternatively “6” when used in combination with a diacid such as adipic acid, for instance 66, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

Copolymer repeat units are separated by a slash (that is, /). For instance poly(hexamethylene decanediamide/decamethylene decanediamide) is abbreviated PA610/1010 (75125), and the values in brackets are the mole % repeat unit of each repeat unit in the copolymer.

In various embodiments the copolyamides disclosed herein consist essentially of 8 to 92 mole percent repeat units of the formula

C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12.

In one embodiment the copolyamides have 8 to 50 mole percent repeat units of formula (I) and 50 to 92 repeat units of formula (II).

In one embodiment the copolyamides have 40 to 50 mole percent repeat units of formula (I) and 50 to 60 repeat units of formula (II).

In another embodiment the copolyamides have 8 to 12 mole percent repeat units of formula (I) and 92 to 88 repeat units of formula (II)

Preferred embodiments are any of those copolyamides disclosed above wherein n is 6.

The term “consist essentially of” means the embodiment necessarily includes the listed ingredients and is open to unlisted ingredients that do not materially affect the basic and novel properties of the invention. Herein, for instance, the term as applied to the copolyamide, means the copolyamide includes the repeat units of formula (I) and (II), and may include other repeat units in small amounts, so long as the additional repeat units do not materially affect the basic and novel properties of the invention. The basic properties of this invention include a delta MP-FP of less than 40° C., and preferably less than 30° C.; and a tan delta peak value, as measured with DMA, of less than 0.23; and preferably less than 0.20.

In one embodiment the copolyamides have a delta MP-FP, as measured with DSC, of less than 40° C., and preferably less than 30° C.; and a tan delta peak value, as measured with DMA, of less than 0.23; and preferably less than 0.20.

The copolyamides of the invention are preferably prepared from aliphatic dioic acids and aliphatic diamines, at least one of which is bio-sourced or “renewable”. By “bio-sourced” is meant that the primary feed-stock for preparing the dioic acid and/or diamine is a renewable biological source, for instance, vegetable matter including grains, vegetable oils, cellulose, lignin, fatty acids; and animal matter including fats, tallow, oils such as whale oil, fish oils, and the like. These bio-sources of dioic acids and aliphatic diamines have a unique characteristic in that they all possess high levels of the carbon isotope ¹⁴C; as compared to fossil or petroleum sources of the dioic acids and aliphatic diamines. This unique isotope feature remains unaffected by non-nuclear, conventional chemical modifications. Thus the ¹⁴C isotope level in bio-sourced materials provides an unalterable feature that allows any downstream products, such as polyamides; or products comprising the polyamides, to be unambiguously identified as comprising a bio-sourced material. Furthermore, the analysis of ¹⁴C isotope level in dioic acids, diamines and downstream product is sufficiently accurate to verify the percentage of bio-sourced carbon in the downstream product.

The copolyamides are prepared from aliphatic dioic acids and aliphatic diamines using conventional chemical methods as are well known in the art of polyamides. See, Kohan in “Nylon Plastics Handbook,” Melvin I. Kohan, Ed., Hanser Publlishers (1995).

Preferred renewable copolyamides are wherein the repeat units (I) and (II) are prepared from C16 and C18 dioic acids derived from vegetable oils selected from the group consisting of soybean oil, palm oil, sunflower oil, olive oil, cotton seed oil, peanut oil and corn oil.

Bio-sources of the aliphatic dioic acids are available by well known fermentation processes combined with conventional isolation and purification processes. For instance, 1,14-tetradecanedioic acid is available by biofermentation of methyl myristate using Candida tropicalis according to the procedures disclosed in U.S. Pat. Nos. 6,004,784 and 6,066,480, hereby incorporated by reference. Other α,ω-alkanedicarboxylic acids are also available using similar fermentation methods with other fatty acids, or fatty esters. The aliphatic dioic acids can be isolated from the fermentation broth using well known procedures in the art. For instance, GB patent 1,096,326, disclose the ethyl acetate extraction of a fermentation broth, followed by esterification of the extract with methanol and sulfuric acid catalysis to provide the corresponding dimethyl ester of the dioic acid.

Preferred renewable linear dioic acids useful in the invention, rich in C16 and C18 dioic acids, may be derived from vegetable oils selected from the group consisting of soybean oil, palm oil, sunflower oil, olive oil, cotton seed oil castor oil, canola oil, and corn oil. Alternatively, fatty acids or fatty acid esters derived from triacylglycerides may be used as a feedstock. The biomass based triglycerides are first hydrotreated according to procedures disclosed in WO 2010/068904 to provide renewable C16/C18 linear alkanes in high yield. The C16 and C18 linear alkanes can be purified using the distillation procedures disclosed herein in the material section to provide greater than 98 wt % purity and preferably greater than 99 wt % purity C16 and C18 alkanes, respectively.

The linear alkane(s) of Cₙ chain length may be fermented separately to the desired linear dicarboxylic acid(s) of Cₙ chain length, where n=16 or 18. Methods and microorganisms for fermenting linear alkanes to linear dicarboxylic acids are known, such as those described, for example, in U.S. Pat. Nos. 5,254,466; 5,620,878; 5,648,247, 7,405,063 and Published Application US 2004/0146999 (each of which is by this reference incorporated in its entirety as a part hereof for all purpose); and in EP 1 273 663. Methods for recovering linear dicarboxylic acids from fermentation broth are also known, as disclosed in at least some of the references cited above and also, for example, in published patent application WO 2000/20620 and U.S. Pat. No. 6,288,275.

Fermentation may be by any suitable biocatalyst having alkane hydroxylating activity. The alkane hydroxylating activity is responsible for the hydroxylation of a terminal methyl group. Additional enzymatic steps are required for further oxidation to the carboxylate form. Two further oxidation steps, catalyzed by alcohol oxidase [Kemp et al., Appl. Microbiol. and Biotechnol., 28:370 (1988)] and alcohol dehydrogenase, lead to the corresponding carboxylate.

Particularly suitable as biocatalysts are microorganisms that are genetically engineered for enhanced alkane hydroxylating activity. The enhanced hydroxylating activity may be due to enhanced alkane monooxygenase, fatty acid monooxygenase or cytochrome P450 reductase separately or in various combinations. For example, suitable biocatalysts may be microorganisms such as yeast of the genera Candida, Pichia, or Saccharomyces that have been genetically engineered to express increased cytochrome P450 monooxygenase activity and/or increased cytochrome P450 reductase activity. Separately or in addition, a suitable biocatalyst may be genetically engineered to disrupt the β-oxidation pathway. Disrupting the β-oxidation pathway increases metabolic flux to the ω-oxidation pathway and thereby increases the yield and selectivity of a bioprocess for conversion of alkanes to mono- and diterminal carboxylates.

As an example, US Published Application 2004/0146999 discloses a process for the bioproduction of C₆ to C₂₂ mono- and di-carboxylic acids by contacting, under aerobic conditions, transformed Pichia pastoris characterized by a genetically engineered enhanced alkane hydroxylating C activity or transformed Candida maltosa characterized by a genetically engineered enhanced alkane hydroxylating activity with at least one C₆ to C₂₂ straight chain hydrocarbon in the form CH₃(CH₂)ₓCH₃ wherein x=4 to 20. The reference also discloses a transformed Pichia pastoris comprising at least one foreign gene encoding a cytochrome P450 monooxygenase and at least one foreign gene encoding a cytochrome P450 reductase, each gene operably linked to suitable regulatory elements such that alkane hydroxylating activity is enhanced. Also disclosed are genetically-engineered Candida maltosa strains that have enhanced cytochrome P450 activity and/or gene disruptions in the β-oxidation pathway. Genetic engineering may be as described in US Published Application 2004/0146999 or by additional methods well known to one skilled in the art. Known promoters, coding regions, and termination signals may be used for expression of enzyme activities.

The copolyamides of various embodiments preferably has a carbon content wherein the carbon content comprises at least 50 percent modern carbon (pMC), as determined with the ASTM-D6866 Biobased Determination method. In other embodiments the polyimide has a modern carbon content of at least 60, 65, 70, 75, 80, and 85 pMC, respectively, as determined with the ASTM-D6866 Method.

The ASTM-D6866 method to derive a “Biobased content” is built on the same concepts as radiocarbon dating, but without use of the age equations. The method relies on determining a ratio of the amount of radiocarbon (¹⁴C) in an unknown sample to that of a modern reference standard. The ratio is reported as a percentage with the units “pMC” (percent modern carbon). If the material being analyzed is a mixture of present day radiocarbon and fossil carbon (fossil carbon being derived from petroleum, coal, or a natural gas source), then the pMC value obtained correlates directly to the amount of Biomass material present in the sample.

The modern reference standard used in radiocarbon dating is a National Institute of Standards and Technology—USA (NIST-USA) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). This was a logical point in time to use as a reference for archaeologists and geologists. For those using radiocarbon dates, AD 1950 equals “zero years old”. It also represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn, vegetable oils, etc, and materials derived therefrom, would give a radiocarbon signature near 107.5 pMC.

The radiocarbon dating isotope (¹⁴C), with its nuclear half life of 5730 years, clearly allows one to apportion specimen carbon between fossil carbon (“dead”) and biospheric (“alive”) feedstocks. Fossil carbon, depending upon its source, has very close to zero ¹⁴C content.

Combining fossil carbon with present day carbon into a material will result in a dilution of the present day pMC content. By presuming 107.5 pMC represents present day biomass materials and 0 pMC represents petroleum (fossil carbon) derivatives, the measured pMC value for that material will reflect the proportions of the two component types. Thus, a material derived 100% from present day vegetable oil would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent Biobased content result of 93%. This value is referred to as the “Mean Biobased Result” and assumes all the components within the analyzed material were either present day living or fossil in origin.

The results provided by the ASTM D6866 method are the Mean Biobased Result and encompasses an absolute range of 6% (plus and minus 3% on either side of the Mean Biobased Result) to account for variations in end-component radiocarbon signatures. It is presumed that all materials are present day or fossil in origin. The result is the amount of biobased component “present” in the material, not the amount of biobased material “used” in the manufacturing process.

Several commercial analytical laboratories have capabilities to perform ASTM-D6866 method. The analyses herein were conducted by Beta Analytics Inc, Miami Fl., USA.

Another embodiment is a thermoplastic composition comprising
A) a copolyamide consisting essentially of 8 to 92 mole percent repeat units of the formula

—C(O)(CH₂)₁₄C(O)NH(CH₂)ₙNH— (I)

and 8 to 92 mole percent repeat units of the formula

—C(O)(CH₂)₁₆C(O)NH(CH₂)ₙNH— (II)

wherein n is an integer selected from 4, 6, 10 and 12; and at least one component selected from the group consisting of:
B) 0 to 60 weight percent of at least one reinforcing agent;
C) 0 to 30 weight percent of at least one polymeric toughener;
D) 0 to 10 weight percent of a functional additive;
   wherein the weight percents of A), B), C), and D) are based on the total weight of the thermoplastic composition, and at least one component of the group B), C) and D) is present in at least 0.1 weight percent.

Another embodiment of the invention is a thermoplastic composition consisting essentially of components (A), (B), (C) and (D), as disclosed above.

Preferably the thermoplastic composition comprises at least 20 weight percent, and more preferably, at least 25 weight percent of copolyamide.

All the embodiments disclosed above for the copolyamide consisting essentially of formula (I) and (II) are also applicable to the thermoplastic composition.

The thermoplastic composition may comprise 0 to about 60 weight percent of one or more reinforcement agents. In various embodiments 0.1 to about 60 weight percent, and preferably about 10 to 60 weight percent, 15 to 50 weight percent and 20 to 45 weight percent of reinforcement agent is present. The reinforcement agent may be any filler, but is preferably selected from the group consisting of calcium carbonate, glass fibers with circular cross-section, glass fibers with noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof. Glass fibers, glass flakes, talc, and mica are preferred reinforcement agents.

The thermoplastic composition may comprise 0 to 30 weight percent polymeric toughener. The polymeric toughener is a polymer, typically an elastomer having a melting point and/or glass transition points below 25° C., or is rubber-like, i.e., has a heat of melting (measured by ASTM Method D3418-82) of less than about 10 J/g, more preferably less than about 5 J/g, and/or has a melting point of less than 80° C., more preferably less than about 60° C. Preferably the polymeric toughener has a weight average molecular weight of about 5,000 or more, more preferably about 10,000 or more, when measured by gel permeation chromatography using polyethylene standards.

The polymeric toughener can be a functionalized toughener, a nonfunctionalized toughener, or blend of the two.

A functionalized toughener has attached to it reactive functional groups which can react with the polyamide. Such functional groups are usually “attached” to the polymeric toughener by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber (such as an ethylene/α-olefin copolymer, an α-olefin being a straight chain olefin with a terminal double bond such a propylene or 1-octene) using free radical grafting techniques. The resulting grafted polymer has carboxylic anhydride and/or carboxyl groups attached to it.

Ethylene copolymers are an example of a polymeric toughening agent wherein the functional groups are copolymerized into the polymer, for instance, a copolymer of ethylene and a (meth)acrylate monomer containing the appropriate functional group. Herein the term (meth)acrylate means the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl (meth)acrylate. In addition to ethylene and a functionalized (meth)acrylate monomer, other monomers may be copolymerized into such a polymer, such as vinyl acetate, unfunctionalized (meth)acrylate esters such as ethyl (meth)acrylate, n-butyl (meth)acrylate, i-butyl (meth)acrylate and cyclohexyl (meth)acrylate. Polymeric tougheners include those listed in U.S. Pat. No. 4,174,358, which is hereby incorporated by reference.

Another functionalized toughener is a polymer having carboxylic acid metal salts. Such polymers may be made by grafting or by copolymerizing a carboxyl or carboxylic anhydride containing compound to attach it to the polymer. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

Polymeric tougheners useful in the invention include those selected from the group consisting of linear low density polyethylene (LLDPE) or linear low density polyethylene grafted with an unsaturated carboxylic anhydride, ethylene copolymers; ethylene/α-olefin or ethylene/α-olefin/diene copolymer grafted with an unsaturated carboxylic anhydride; core-shell polymers, and nonfunctionalized tougheners, as defined herein.

Herein the term ethylene copolymers include ethylene terpolymers and ethylene multi-polymers, i.e. having greater than three different repeat units. Ethylene copolymers useful as polymeric tougheners in the invention include those selected from the group consisting of ethylene copolymers of the formula E/X/Y wherein:

E is the radical formed from ethylene;

X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of E/X/Y copolymer;

Y is one or more radicals formed from monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl (meth)acrylate, 2-hydroxyethyl (meth)acrylate, 2-isocyanatoethyl (meth)acrylate and glycidyl vinyl ether; wherein Y is from 0.5 to 35 weight % of the E/X/Y copolymer, and preferably 0.5-20 weight percent of the E/X/Y copolymer, and E is the remainder weight percent and preferably comprises 40-90 weight percent of the E/X/Y copolymer.

It is preferred that the functionalized toughener contain a minimum of about 0.5, more preferably 1.0, very preferably about 2.5 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener. In one embodiment the polymeric toughener comprises about 2.5 to about 10 weight percent of repeat units and/or grafted molecules containing functional groups or carboxylate salts (including the metal).

It has been found that often the toughness of the composition is increased by increasing the amount of functionalized toughener and/or the amount of functional groups and/or metal carboxylate groups. However, these amounts should preferably not be increased to the point that the composition may crosslink (thermoset), especially before the final part shape is attained, and/or the first to melt tougheners may crosslink each other. Increasing these amounts may also increase the melt viscosity, and the melt viscosity should also preferably not be increased so much that molding is made difficult.

Nonfunctionalized tougheners may also be present in addition to a functionalized toughener. Nonfunctionalized tougheners include polymers such as ethylene/α-olefin/diene (EPDM) rubber, polyolefins including polyethylene (PE) and polypropylene, and ethylene/α-olefin (EP) rubbers such as ethylene/1-octene copolymer, and the like such as those commercial copolymers under the ENGAGE® brand from Dow Chemical, Midland Mich. Other nonfunctional tougheners include the styrene-containing polymers including acrylonitrile-styrene copolymer, acrylonitrile-butadiene-styrene copolymer, styrene-isoprene-styrene copolymer, styrene-hydrogenated isoprene-styrene copolymer, styrene-butadiene-styrene copolymer, styrene-hydrogenated butadiene-styrene copolymer, styrenic block copolymer, (are not the above listed polymers block or random polymers?) polystyrene. For example, acrylonitrile-butadiene-styrene, or ABS, is a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of poly(styrene acrylonitrile).

Other polymeric tougheners useful in the invention are having a (vinyl aromatic comonomer) core comprising an ethylene copolymer as disclosed above, the core optionally cross-linked and optionally containing a vinyl aromatic comonomer, for instance styrene; and a shell comprising another polymer that may include polymethyl methacrylate and optionally contain functional groups including epoxy, or amine. The core-shell polymer may be made up of multiple layers, prepared by a multi-stage, sequential polymerization technique of the type described in U.S. Pat. No. 4,180,529. Each successive stage is polymerized in the presence of the previously polymerized stages. Thus, each layer is polymerized as a layer on top of the immediately preceding stage.

When used, the minimum amount of polymeric toughener is 0.5, preferably 2, and more preferably about 8 weight percent of the melt-blended thermoplastic composition, while the maximum amount of polymeric toughener is about 30 weight percent, preferably about 25 weight percent. It is to be understood than any minimum amount may be combined with any maximum amount to form a preferred weight range.

Useful polymeric tougheners include:

(a) A copolymer of ethylene, glycidyl (meth)acrylate, and optionally one or more (meth)acrylate esters.

(b) An ethylene/α-olefin or ethylene/α-olefin/diene (EPDM) copolymer grafted with an unsaturated carboxylic anhydride such as maleic anhydride.

(c) A copolymer of ethylene, 2-isocyantoethyl (meth)acrylate, and optionally one or more (meth)acrylate esters.

(d) a copolymer of ethylene and acrylic acid reacted with a Zn, Li, Mg or Mn compound to form the corresponding ionomer.

The thermoplastic composition may include 0 to 10 weight percent of functional additives such as thermal stabilizers, plasticizers, colorants, lubricants, mold release agents, and the like. Such additives can be added according to the desired properties of the resulting material, and the control of these amounts versus the desired properties is within the knowledge of the skilled artisan

The thermoplastic composition may include a thermal stabilizer selected from the group consisting of polyhydric alcohols having more than two hydroxyl groups and having a number average molecular weight (Mₙ) of less than 2000; one or more polyhydroxy polymer(s) having a number average molecular weight of at least 2000 and selected from the group consisting of ethylene/vinyl alcohol copolymer and polyvinyl alcohol; organic stabilizer(s) selected from the group consisting of secondary aryl amines and hindered amine light stabilizers (HALS), hindered phenols and mixtures of these; copper salts; and mixtures these.

The thermoplastic composition may comprise 0 to 10 weight percent, and preferably 0.1 to 10 weight percent, of one or more polyhydric alcohols having more than two hydroxyl groups and having a number average molecular weight (Mₙ) of less than 2000 of less than 2000 as determined for polymeric materials with gel permeation chromatography (GPC)

Polyhydric alcohols may be selected from aliphatic hydroxylic compounds containing more than two hydroxyl groups, aliphatic-cycloaliphatic compounds containing more than two hydroxyl groups, cycloaliphatic compounds containing more than two hydroxyl groups, aromatic and saccharides.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the polyhydric alcohol used in the thermoplastic composition is pentaerythritol, dipentaerythritol, tripentaerythritol, di-trimethylolpropane, O-mannitol, D-sorbitol and xylitol. More preferably, the polyhydric alcohol used is dipentaerythritol and/or tripentaerythritol. A most preferred polyhydric alcohol is dipentaerythritol.

In various embodiments the content of said polyhydric alcohol in the thermoplastic composition is 0.25 to 10 weight percent, preferably 0.25 to 8 weight percent, and more preferably 0.25 to 5, and 1 to 4 weight percent.

The thermoplastic composition may comprise 0.1 to 10 weight percent of at least one polyhydroxy polymer having a number average molecular weight (Mₙ) of at least 2000, selected from the group consisting of ethylene/vinyl alcohol copolymers; as determined for polymeric materials with gel permeation chromatography (GPC). Preferably the polyhydroxy polymer has a Mₙ of 5000 to 50,000.

In one embodiment the polyhydroxy polymer is an ethylene/vinyl alcohol copolymer (EVOH). The EVOH may have a vinyl alcohol repeat content of 10 to 90 mol % and preferably 30 to 80 mol %, 40 to 75 mol %, 50 to 75 mol %, and 50 to 60 mol %, wherein the remainder mol % is ethylene. A suitable EVOH for the thermoplastic composition is Soarnol® A or D copolymer available from Nippon Gosei (Tokyo, Japan) and EVAL® copolymers available from Kuraray, Tokyo, Japan.

The thermoplastic composition may comprise 1 to 10 weight percent; and preferably 1 to 7 weight percent and more preferably 2 to 7 weight percent polyhydroxy polymer based on the total weight of the thermoplastic polyamide composition.

The thermoplastic composition may comprise 0 to 3 weight percent of one or more organic co-stabilizer(s) having a 10% weight loss temperature, as determined by thermogravimetric analysis (TGA), of greater than 30° C. below the melting point of the polyamide resin, if a melting point is present, or at least 250° C. if said melting point is not present, selected from the group consisting of secondary aryl amines, hindered phenols and hindered amine light stabilizers (HALS), and mixtures thereof.

For the purposes of this invention, TGA weight loss will be determined according to ASTM D 3850-94, using a heating rate of 10° C./min, in air purge stream, with an appropriate flow rate of 0.8 mL/second. The one or more co-stabilizer(s) preferably has a 10% weight loss temperature, as determined by TGA, of at least 270° C., and more preferably 290° C., 320° C., and 340° C., and most preferably at least 350° C.

The one or more co-stabilizers preferably are present from 0.1 to 3 weight percent, more preferably 0.2 to 1.2 weight percent; or more preferably from 0.5 to 1.0 weight percent, based on the total weight of the thermoplastic composition.

By secondary aryl amine is meant an amine compound that contains two carbon radicals chemically bound to a nitrogen atom where at least one, and preferably both carbon radicals, are aromatic. Preferably, at least one of the aromatic radicals, such as, for example, a phenyl, naphthyl or heteroaromatic group, is substituted with at least one substituent, preferably containing 1 to about 20 carbon atoms.

Examples of suitable secondary aryl amines include 4,4′ di(α,α-dimethylbenzyl)diphenylamine available commercially as Naugard 445 from Uniroyal Chemical Company, Middlebury, Conn.; the secondary aryl amine condensation product of the reaction of diphenylamine with acetone, available commercially as Aminox from Uniroyal Chemical Company; and pare-(paratoluenesulfonylamido) diphenylamine also available from Uniroyal Chemical Company as Naugard SA. Other suitable secondary aryl amines include N,N′-di-(2-naphthyl)-p-phenylenediamine, available from ICI Rubber Chemicals, Calcutta, India. Other suitable secondary aryl amines include 4,4′-bis(α,α-tertiaryoctyl)diphenylamine, 4,4′-bis(α-methylbenzhydryl)diphenylamine, and others from EP 0509282 B1.

The hindered amine light stabilizers (HALS) may be one or more hindered amine type light stabilizers (HALS). HALS are compounds of the following general formulas and combinations thereof:

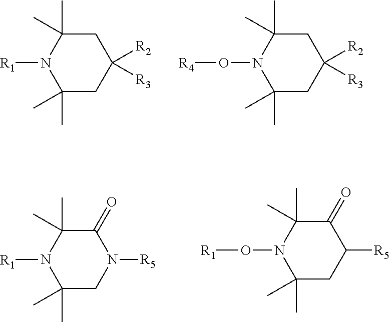

In these formulas, R₁ up to and including R₅ are independent substituents. Examples of suitable substituents are hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. A hindered amine light stabilizer may also form part of a polymer or oligomer.

Preferably, the HALS is a compound derived from a substituted piperidine compound, in particular any compound derived from an alkyl-substituted piperidyl, piperidinyl or piperazinone compound, and substituted alkoxypiperidinyl compounds. Examples of such compounds are: 2,2,6,6-tetramethyl-4-piperidone; 2,2,6,6-tetramethyl-4-piperidinol; bis-(1,2,2,6,6-pentamethyl piperidyl)-(3′,5-di-tart-butyl-4′-hydroxybenzyl) butylmalonate; di-(2,2,6,6-tetramethyl-4-piperidyl) sebacate (Tinuvin® 770, MW 481); oligomer of N-(2-hydroxyethyl)-2,2,6,6-tetramethyl-4-piperidinol and succinic acid (Tinuvin® 622); oligomer of cyanuric acid and N,N-di(2,2,6,6-tetramethyl-4-piperidyl)-hexamethylene diamine; bis-(2,2,6,6-tetramethyl-4-piperidinyl) succinate; bis-(1-octyloxy-2,2,6,6-tetramethyl-4-piperidinyl) sebacate (Tinuvin® 123); bis-(1,2,2,6,6-pentamethyl-4-piperidinyl) sebacate (Tinuvin® 765); Tinuvin® 144; Tinuvin® XT850; tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinamine; 2,2′-[(2,2,6,6-tetramethyl-piperidinyl)-imino]-bis-[ethanol]; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); 8-acetyl-3-dothecyl-7,7,9,9-tetramethyl-1,3,8-triazaspiro(4,5)decane-2,4-diene; polymethylpropyl-3-oxy-[4(2,2,6,6-tetramethyl)-piperidinyl]siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl) maleimide and N-stearyl maleimide; 1,2,3,4-butanetetracarboxylic acid, polymer with beta,beta,beta′,beta′-tetramethyl-2,4,8,10-tetraoxaspire[5.5]undecane-3,9-diethanol, 1,2,2,6,6-pentamethyl-4-piperidinyl ester (Mark® LA63); 2,4,8,10-tetraoxaspiro[5.5]undecane-3,9-diethanol,beta,beta,beta′,beta′-tetramethyl-polymer with 1,2,3,4-butanetetracarboxylic acid, 2,2,6,6-tetramethyl-4-piperidinyl ester (Mark® LA68); D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosan-21-one-2,2,4,4-tetramethyl-20-(oxiranylmethyl) (Hostavin® N30); propanedioic acid, [(4-methoxyphenyl)methylene]-, bis(1,2,2,6,6-pentamethyl-4-piperidinyl) ester (Sanduvor® PR 31); formamide, N,N′-1,6-hexanediyibis[N-(2,2,6,6-tetramethyl-4-piperidinyl (Uvinul® 4050H); 1,3,5-triazine-2,4,6-triamine, N,N′″-[1,2-ethanediylbis [[[4,6-bis[butyl(1,2,2,6,6-pentamethyl-4-piperidinyl)amino]-1,3,5-triazine-2-yl]imine]-3,1-propanediyl]]-bis[N′,N″-dibutyl-N′,N″-bis(1,2,2,6,6-pentamethyl-4-piperidinyl) (Chimassorb® 119 MW 2286); poly[[6-[(1,1,3,33-tetramethylbutyl) amino]-1,3,5-triazine-2,4-diyl][(2,2,6,6-tetramethyl-4-peperidinyl)-imino]-1,6-hexanediyl [(2,2,6,6-tetramethyl-4-piperidinyl)imino]](Chimassorb® 944 MW 2000-3000); 1,5-dioxaspiro (5,5) undecane 3,3-dicarboxylic acid, bis(2,2,6,6-tetramethyl-4-peridinyl) ester (Cyasorb® UV-500); 1,5-dioxaspiro (5,5) undecane 3,3-dicarboxylic acid, bis (1,2,2,6,6-pentamethyl-4-peridinyl) ester (Cyasorb® UV-516); N-2,2,6,6-tetramethyl-4-piperidinyl-N-amino-oxamide; 4-acryloyloxy-1,2,2,6,6-pentamethyl-4-piperidine. 1,5,8,12-tetrakis[2′,4′-bis(1″,2″,2″,6″,6″-pentamethyl-4″-piperidinyl(butyl)amino)-1′,3,5′-triazine-6′-yl]-1,5,8,12-tetraazadodecane; HALS PB-41 (Clariant Huningue S. A.); Nylostab® S-EED (Clariant Huningue S. A.); 3-dodecyl-1-(2,2,6,6-tetramethyl-4-piperidyl)-pyrrolidin-2,5-dione; Uvasorb® HA88; 1,1′-(1,2-ethane-di-yl)-bis-(3,3′,5,5′-tetra-methyl-piperazinone) (Good-rite® 3034); 1,1′1″-(1,3,5-triazine-2,4,6-triyltris ((cyclohexylimino)-2,1-ethanediyl)tris(3,3,5,5-tetramethylpiperazinone) (Good-rite® 3150) and; 1,1′1′-(1,3,5-triazine-2,4,6-triyitris((cyclohexylimino)-2,1-ethanediyl)tris(3,3,4,5,5-tetramethylpiperazinone) (Good-rite® 3159). (Tinuvin® and Chimassorb® materials are available from Ciba Specialty Chemicals; Cyasorb® materials are available from Cytec Technology Corp.; Uvasil® materials are available from Great Lakes Chemical Corp.; Saduvor®, Hostavin®, and Nylostab® materials are available from Clariant Corp.; Uvinul® materials are available from BASF; Uvasorb® materials are available from Partecipazioni Industriali; and Good-rite® materials are available from B.F. Goodrich Co. Mark® materials are available from Asahi Denka Co.)

Other specific HALS are selected from the group consisting or di-(2,2,6,6-tetramethyl-4-piperidyl) sebacate (Tinuvin® 770, MW 481) Nylostab® S-EED (Clariant Huningue S. A.); 1,3,5-triazine-2,4,6-triamine, N,N′″[1,2-ethanediylbis [[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb® 119 MW 2286); and poly[[6-[(1,1,3,33-tetramethylbutyl) amino]-1,3,5-triazine-2,4-diyl][(2,2,6,6-tetramethyl-4-peperidinyl)-imino]-1,6-hexanediyl [(2,2,6,6-tetramethyl-4-piperidinyl)imino]] (Chimassorb® 944 MW 2000-3000).

Mixtures of secondary aryl amines and HALS may be used. A preferred embodiment comprises at least two co-stabilizers, at least one selected from the secondary aryl amines; and at least one selected from the group of HALS, as disclosed above, wherein the total weight percent of the mixture of co-stabilizers is at least 0.5 wt percent, and preferably at least 0.9 weight percent.

Mixtures of polyhydric alcohols, secondary aryl amines, and HALS may be used. A preferred embodiment includes at least one polyhydric alcohol and at least one secondary aryl amine.

The thermoplastic composition may comprise about 0.1 to at or about 1 weight percent, or more preferably from at or about 0.1 to at or about 0.7 weight percent, based on the total weight of the polyamide composition, of copper salts. Copper halides are mainly used, for example CuI, CuBr, Cu acetate and Cu naphthenate. Cu halides in combination with alkali halides such as Kl, KBr or LiBr may be used. Copper salts in combination with at least one other stabilizer selected from the group consisting of poyhydric alcohols; polyhric polymers, secondary aryl amines and HALS; as disclosed above, may be used as thermal stabilizers.

Herein the thermoplastic composition is a mixture by melt-blending, in which all polymeric ingredients are adequately mixed, and all non-polymeric ingredients are adequately dispersed in a polymer matrix. Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing filler presents a long physical shape (for example, a long glass fiber), drawing extrusion molding may be used to prepare a reinforced composition.

Another embodiment is the use of a polyamide or copolyamide consisting essentially of repeat units selected from the group consisting of formulas

—C(O)(CH₂)₁₄C(O)NH(CH₂)ₙNH— (I)

—C(O)(CH₂)₁₆C(O)NH(CF₁₂)ₙNH— (II);

and mixtures of (I) and (II); wherein n is an integer selected from 4, 6, 10 and 12; to provide ZnCl₂ salt resistance in injection molded thermoplastic articles. All the embodiments disclosed above for the copolyamide consisting essentially of formula (I) and (II) are also applicable to their use in providing ZnCl₂ salt resistance.

Another embodiment is the use of a polyamide or copolyamide consisting essentially of repeat units selected from the group consisting of formulas

—C(O)(CH₂)₁₄C(O)NH(CH₂)ₙNH— (I)

—C(O)(CH₂)₁₆C(O)NH(CH₂)ₙNH— (II);

and mixtures of (I) and (II); wherein rectangular test pieces measuring 50 mm×12 mm×3.2 mm, prepared from said polyamide composition, have a resistance to 50% by weight aqueous solution of ZnCl₂ of at least 24 hours at 50° C., when measured according to ASTM D1693, Condition A, adapted for determining stress cracking resistance of the polyamide compositions as disclosed herein.

In another aspect, the present invention relates to a method for manufacturing an article by shaping the melt-mixed compositions. Examples of articles are films, laminates, filaments, fibers, monolayer tubes, hoses, pipes, multi-layer tubes, hoses and pipes with one or more layers formed from the above composition, and automotive parts including engine parts. By “shaping”, it is meant any shaping technique, such as for example extrusion, injection molding, thermoform molding, compression molding, blow molding, filament spinning, sheet casting or film blowing.

The molded or extruded thermoplastic articles disclosed herein may have application in many vehicular, industrial and consumer product components that meet one or more of the following requirements: resistance against road salts, hydrolysis by water and coolants such as glycol solutions, fuels, alcohols, oils, chlorinated water; high impact resistance especially under cold environment; improved retention of mechanical properties at high temperatures such as automotive under-hood temperatures; significant weight reduction (over conventional metals, for instance); and noise reduction allowing more compact and integrated design. Specific molded or extruded thermoplastic articles are selected from the group consisting of automotive coolant lines, fuel lines, oil lines, truck air brake tubes, radiator end tanks, engine mounts, torque rods, filaments used for industrial and consumer applications such as brushes and those used for paper machine belts, and sporting goods such as lamination layers for skis and ski boots.

Another embodiment is a tubing comprising:
(A) a copolyamide consisting essentially of 8 to 92 mole percent repeat units of the formula

—C(O)(CH₂)₁₄C(O)NH(CH₂)ₙNH— (I); and
8 to 92 mole percent repeat units of the formula

—C(O)(CH₂)₁₆C(O)NH(CH₂)ₙNH— (II);
wherein n is an integer selected from 4, 6, 10 or 12;
(B) 0 to 30 weight percent of at least one polymeric toughener;
(D) 0 to 10 weight percent thermal stabilizer; and
(E) 0 to 20 weight percent of plasticizer; and
wherein the weight percent of (A), (B), and (D) and (E) are based on the total weight of the thermoplastic composition.

The thermal stabilizer and polymeric toughener may be present as disclosed above for the thermoplastic compositions. The tubing composition may include a sulfonamide plasticizer. Suitable sulfonamide plasticizers include aromatic sulfonamides such as benzenesulfonamides and toluenesulfonamides. Examples of suitable sulfonamides include N-alkyl benzenesulfonamides and toluenesulfonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

Further examples of palsticizers include polyamide oligomers with a number average molecular weight of 800 to 5000 g/mol, as disclosed in U.S. Pat. No. 5,112,908, herein incorporated by reference, and US patent publication 2009/0131674 A1. Preferred polyamide oligomers have an inherent viscosity less than 0.5.

The plasticizer may be incorporated into the flexible tubing composition by melt-blending the copolyamide with plasticizer and, optionally, other ingredients, or during polymerization. If the plasticizer is incorporated during polymerization, the polyimide monomers are blended with one or more plasticizers prior to starting the polymerization cycle and the blend is introduced to the polymerization reactor. Alternatively, the plasticizer can be added to the reactor during the polymerization cycle.

When present, the plasticizer is present in the composition in about 1 to about 20 weight percent, or more preferably in about 6 to about 18 weight percent, or yet more preferably in about 8 to about 15 weight percent, wherein the weight percentages are based on the total weight of the composition.

Other specific molded thermoplastic articles are selected from the group consisting of charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers.

The present invention is further illustrated by the following examples. It should be understood that the following examples are for illustration purposes only, and are not used to limit the present invention thereto.

### Methods

### Melting Point

Herein melting points were as determined with DSC at a scan rate of 10° C./min in the first heating scan, wherein the melting point is taken at the maximum of the endothermic peak.

### Freezing Point

Herein freezing points were as determined with DSC at a scan rate of 10° C./min in the cooling cycle as per ASTM D3418.

### Inherent Viscosity

Inherent viscosity (IV) was measured on a 0.5% solution of copolyamide in m-cresol at 25° C.,

### % Biobased Carbon

ASTM-D6866 Method B Biobased Determination method were conducted by Beta Analytics Inc. Miami Fl, USA, to determine the % biobased carbon.

### Physical Properties Measurement

Copolyamides obtained from single preparation batches or multiple preparation batches (2 to 3 batches) were cube blended, dried and then injection molded into test bars. The tensile and flexural properties were measured as per ASTM D638 and ASTM D790 test procedures, respectively. Yield stress and Young's modulus were measured using 115 mm (4.5 in) long and 3.2 mm (0.13 in) thick type IV tensile bars per ASTM D638-02a test procedure with a crosshead speed of 50 mm/min (2 in/min). Flexural modulus was measured using 3.2 mm (0.13 in) thick test pieces per ASTM D790 test procedure with a 50 mm (2 in) span, 5 mm (0.2 in) load and support nose radii and 1.3 mm/min (0.05 in/min) crosshead speed.

### DMA Test Method

Dynamic mechanical analysis (DMA) test was done using TA instruments DMA Q800 equipment. Injection molded test bars nominally measuring 18 mm×12.5 mm×3.2 mm were used in single cantilever mode by clamping their one end. The bars were equilibrated to −0.140° C. for 3 to 5 minutes, and then DMA rest was carried out with following conditions: temperature ramping up from −140° C. to +150° C. at a rate of 2 degrees C./min, sinusoidal mechanical vibration imposed at an amplitude of 20 micrometers and multiple frequencies of 100, 50, 20, 10, 5, 3 and 1 Hz with response at 1 Hz selected for determination of storage modulus (E′) and loss modulus (E″) as a function of temperature. Tan delta was computed by dividing the loss modulus (E″) by the storage modulus (E′).

### Salt Resistance Characterization

The method for stress crack resistance is based on ASTM D1693 which provides a method for determination of environmental stress-cracking of ethylene plastics in presence of surface active agents such as soaps, oils, detergents etc. This procedure was adapted for determining salt stress cracking resistance of copolyamides to salt solutions as follows.

Rectangular test pieces measuring 50 mm×12 mm×3.2 mm were used for the test. A controlled nick was cut into the face of each molded bar as per the standard procedure, the bars were bent into U-shape with the nick facing outward, and positioned into brass specimen holders as per the standard procedure. At least five bars were used for each copolymer. The holders were positioned into large test tubes.

The test fluid used was 50 weight percent zinc chloride solution prepared by dissolving anhydrous zinc chloride into water in 50:50 weight ratio. The test tubes containing specimen holders were filled with freshly prepared salt solution fully immersing the test pieces such that there was at least 12 mm of fluid above the top test piece. The test tubes were positioned upright in a circulating air oven maintained at 50° C. Test pieces were periodically examined for development of cracks. After 191 hours of continued immersion, test pieces were withdrawn from the zinc chloride solution and without wiping, dried in an oven at 50° C. for another 24 hours. Time to first observation of failure in any of the test pieces was recorded.

### Tube Extrusion & Burst Pressure Testing Method

Impact modified melt blended compositions comprising polymer tougheners are dried overnight in a dehumidifying dryer at 65° C. They are extruded into tubes measuring 8.3 mm OD×6.3 mm ID using a Davis Standard tube extrusion system. The system consists of a 50 mm single screw extruder equipped with a tubing die, a vacuum sizing tank with a plate style calibrator, puller and cutter. Die with bushing of 15.2 mm (0,600 in) and a tip of 8.9 mm (0.350 in) is used. Calibrator is 8.3 mm (0.327 in). Extruder barrel temperature profile is about 210° C. at the feed port increasing to about 230° C. at the die. Line speed is typically 4.6 Fri/min (15 ft/min). After establishing a stable process, tubing is cut to 30 cm long pieces and used for burst pressure measurements.

Tube burst pressure is measured using a manual hydraulic pump fitted with a pressure gauge. One end of the tube is attached to the pump using a Swagelok fitting, while the other end of the tube is capped off. The burst pressure is measured by manually raising the fluid pressure until failure. Burst pressure at 125° C. is measured similarly by positioning the tube in a heated air circulating oven and allowing it to equilibrate to temperature for several hours prior to testing. Averages of 3 samples are typically taken.

### Materials

Hydrotreating of Palm Oil to Provide a Linear Alkane Mixture:

Palm oil (50 g; manufactured by T.I. International Ghana Ltd. Of Accra, Ghana) was hydrotreated according to Example 2 of International Publication WO 2010/068904 to provide a mixture containing C14=1 wt %, C15=4 wt %, C16=43 wt %, C17=5 wt %, C18=46.5 wt %, and C18+=0.5 wt %, as determined by GC-FID analysis according to procedures outlined in the reference.

C16 Linear Alkane Separation:

The linear alkane mixture derived from palm oil is fed to a two column distillation train at 1000 g/hour. Both columns contain 25 equilibrium stages, a reboiler, a water cooled condenser, and a reflux splitter. The feed enters the center of the first column at 1000 g/hour, and the first column operates at a reflux ratio of 15:1, a head pressure of 10 mmHg, a reboiler pressure of 30 mmHg, a head temperature of 134.9° C. and a reboiler temperature of 184.3° C. Low boiling materials containing: C14=15.4 wt %, C15=58.9 wt %, and C16=25.7 wt % are collected overhead at 65 g/hour. High boiling materials containing: C15=0.2 wt %, C16=44.2 wt %, C17=5.4 wt %, C18=49.7 wt %, and C18+=0.5 wt % are taken from the reboiler of the first column at 935 g/hour and fed to the center of the second column. The second column operates at a 4:1 reflux ratio, a head pressure of 10 mmHg, a reboiler pressure of 30 mmHg, a head temperature of 148.8° C. and a reboiler temperature of 197.4° C. The product is taken off the top of the second column at 400 g/hour and has the following composition: C15=0.4 wt %, C16=99.5 wt %, and C17=0.1 wt %. High boiling materials are taken from the reboiler of the second column at 535 g/hour and have the following composition: C16=2.9 wt %, C17=9.3 wt %, C18=86.9 wt % and C18+=0.9 wt %.

C18 Linear Alkane Separation:

The linear alkane mixture derived from palm oil is fed to a two column distillation train at 1000 g/hour. Both columns contain 25 equilibrium stages, a reboiler, a water cooled condenser, and a reflux splitter. The feed enters the center of the first column. The column operates at a reflux ratio of 4:1, a head pressure of 10 mmHg and a reboiler pressure of 30 mmHg. The head temperature is 147.3° C. and the reboiler temperature is 200.1° C. Low boiling materials containing: C14=1.9%, C15=7.6 wt %, C16=81.1 wt %, C17=9.2 wt %, and C18=0.2 wt % are taken overhead from the first column at 530 g/hour. High boiling materials containing: C17=0.2 wt %, C18=98.7 wt %, and C18+=1.1 wt % are taken from the reboiler of the first column at 470 g/hour and are introduced into the center of the second column. The second column operates at a reflux ratio of 3:1, a head pressure of 10 mmHg, a reboiler pressure of 30 mmHg, a head temperature of 173.8° C., and a reboiler temperature of 205.0° C. The C18 product is taken overhead from the second column at 460 g/hour and has the following composition: C17=0.2 wt %, C18=99.7 wt %, and C18+=0.1 wt %. High boiling materials are removed from the reboiler of the second column at 10 g/hour and have the following composition: C18=51.6 wt % and C18+=48.4 wt %.

Production of a Mixture of Hexadecanedioic Acid and Octadecanedioic Acid from a Mixture of the Corresponding Chain Length, C16 and C18 Linear Alkanes, by Candida tropicalis CGMCC No. 0206 (Center of General Microbiology of China Committee for Culture Collection of Microorganisms:

Microbial oxidation of a C16/C18 linear alkane mixture is performed according to the general procedures outlined in International Publication WO 2010/068904.

A seed culture of Candida tropicalis CGMCC 0206 is grown up in 25 ml of alkane seed medium: tap water with KH2PO4, 8 g/L, yeast extract, 5 g/L, corn extract, 3 g/L, sucrose, 5 g/L, urea 3 g/L, n-hexadecane 70 ml/L, pH 5.0. Growth occurs at 30° C. on a rotating shaker at 220 rpm for 48 hours. This inoculum is transferred to 500 mL of the same medium and grown under the same conditions for an additional 24 hours.

From the seed growth 500 ml of the seed suspension is added to a 10 L fermenter containing 7 L of fermentation medium: KH2PO4, 8 g/L, corn extract, 1 g/L, NaCl, 1.5 g/L, urea, 1 g/L, C16/C18 (1:1 wt ratio) alkane mixture, 70 g/L, anti-foam, 500 ppm, KN03 6 g/L, dissolved with tap water, pH 7.5 The fermentation is run at 30° C. with oxygen levels maintained at 20% of atmospheric for 4 days. A 20% aqueous NaOH solution is added periodically to adjust pH within 7.5-8. Further additions of 20% wily aqueous KOH maintain pH of the medium at 7.5 for the remainder of the fermentation. The alkane mixture is maintained above 10 g/L in the fermenter by periodic additions

The dicarboxylic acid mixture is recovered from the whole fermenter liquor (cells and supernatant) by acidifying the liquor to pH 2 with 2M phosphoric acid and extracting the precipitated material into 3×5 mL, methyl-tertiary butyl ether. A portion of the ether extract is evaporated to dryness and the recovered dicarboxylic acid mixture is analyzed as a MSTFA (N-methyl-N-trimethylsilyltrifluoroacetamide) derivative and analyzed by gas chromatography by methods known in the art.

Material recovered from the fermentation consists of a nixed diacid product. The C16 diacid is present at 25 g/L or a total yield of 200 g from the fermenter. The C18 diacid product is present at 20 g/L or a total yield of 160 g from the fermenter.

Alternatively hexadecanedioic acid and octadecanedioic acid can be prepared separately by using C16 and C18 linear alkanes, respectively, in the same procedure as described above. The individual dioic acids, purified by crystallization can be mixed to provide a C16/C18 salt solution for copolyamide polymerization as described below.

The following polyamides were prepared by synthesis:

### PA 616

A 10 L autoclave was charged with hexadecanedioic acid (2543 g), an aqueous solution containing 78.4 weight % of hexamethylene diamine (HMD) (1327 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2630 g).

The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 240° C. The pressure was then reduced to 0 psig over about 45 minutes. During this time, the temperature of the contents rose to 255° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The co-polyamide obtained had an inherent viscosity (IV) of 1.00 dl/g. The polymer had a melting point of 207° C., as measured by DSC.

### PA 618

A 10 L autoclave was charged with octadecanedioic acid (2610 g), an aqueous solution containing 78.4 weight % of hexamethylene diamine (HMD) (1240 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2650 g). The process conditions were the same as that described above for PA616.

The co-polyamide obtained had an inherent viscosity (IV) of 1.15 dl/g. The polymer had a melting point of 199° C., as measured by DSC.

### Example 1

Example 1 illustrates the synthesis of PA 616/618 (47/53)

A 10 L autoclave was charged with hexadecane dioic acid (1160 g), octadecanedioic acid (1419 g), an aqueous solution containing 78.4 weight % of hexamethylene diamine (HMD) (1280 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2460 g). The process conditions were the same as that described above for PA616.

The co-polyamide obtained had an inherent viscosity (IV) of 1.04 dl/g. The polymer had a melting point of 185° C., as measured by DSC. Other properties are listed in Table 1.

### Example 2

Example 2 illustrates the synthesis of PA 616/618 (90/10).

Salt Preparation: A 10 L autoclave was charged with hexadecane dioic acid (2275 g), octadecanedioic acid (277 g), an aqueous solution containing 78.4 weight % of hexamethylene diamine (HMD) (1317 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2630 g). The process conditions were the same as that described above for PA616.

The co-polyamide obtained had an inherent viscosity (IV) of 0.97 dl/g. The polymer had a melting point of 204° C., as measured by differential scanning calorimetry (DSC). Other properties are listed in Table 1.

### Example 3

Example 3 illustrates the synthesis of PA 616/618 (10/90).

Salt Preparation: A 10 L autoclave was charged with hexadecane dioic acid (239 g), octadecanedioic acid (2365 g), an aqueous solution containing 78.4 weight % of hexamethylene diamine (HMD) (1248 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2630 g). The process conditions were the same as that described above for PA616.

The co-polyamide obtained had an inherent viscosity (IV) of 1.01 dl/g. The polymer had a melting point of 191° C., as measured by differential scanning calorimetry (DSC). Other properties are listed in Table 1.

### Comparative Example C5

The Copolyamide PA 610/66 (90/10) was prepared by the following process:

Salt Preparation: A 10 L autoclave was charged with adipic acid (182 g), sebacic acid (2269 g), an aqueous solution containing 78.0 weight % of hexamethylene diamine (HMD) (1863 g), an aqueous solution containing 28 weight percent acetic acid (24 g), an aqueous solution containing 1 weight percent sodium hypophosphite (35 g), an aqueous solution containing 1 weight percent Carbowax 8000 (10 g), and water (2630 g).

Process Conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 245° C. The pressure was then reduced to 0 prig over about 45 minutes. During this time, the temperature of the contents rose to 260° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The co-polyamide obtained had an inherent viscosity (IV) of 1.24 dl/g. The polymer had a melting point of 216° C., as measured by DSC.

### Comparative Example C6

The Copolyamide PA 610/66 (60/40) was prepared by the following process:

Salt Preparation: A 10 autoclave was charged with adipic acid (750 g), sebacic acid (1622 g), an aqueous solution containing 78.0 weight % of hexamethylene diamine (HMD) (1963 g), an aqueous solution containing 28 weight percent acetic acid (24 g), an aqueous solution containing 1 weight percent sodium hypophosphite (35 g), an aqueous solution containing 1 weight percent Carbowax 8000 (10 g), and water (2170 g). The process conditions were the same as that described above for PA610/66 90/10.

The co-polyimide obtained had an inherent viscosity (IV) of 1.19 dl/g. The polymer had a melting point of 194° C., as measured by DSC.

### Comparative Example C7

The Copolyamide PA 610/66 (50/50) was prepared by the following process:

Salt Preparation: A 10 L autoclave was charged with adipic acid (960 g), sebacic acid (1383 g), an aqueous solution containing 78.0 weight c/c, of hexamethylene diamine (HMD) (2001 g), an aqueous solution containing 28 weight percent acetic acid (24 g), an aqueous solution containing 1 weight percent sodium hypophosphite (35 g), an aqueous solution containing 1 weight percent Carbowax 8000 (10 g), and water (2170 g). The process conditions were the same as that described above for PA610/66 90/10.

The co-polyamide obtained had an inherent viscosity (IV) of 1.16 dl/g. The polymer had a melting point of 200° C., as measured by DSC.

### Comparative Example C8

The Copolyamide PA 610/66 (10/90) was prepared by the following process:

Salt Preparation: A 10 L autoclave was charged with adipic acid (1914 g), sebacic acid (294 g), an aqueous solution containing 78.0 weight % of hexamethylene diamine (HMD) (2175 g), an aqueous solution containing 28 weight percent acetic acid (24 g), an aqueous solution containing 1 weight percent sodium hypophosphite (35 g), an aqueous solution containing 1 weight percent Carbowax 8000 (10 g), and water (2115 g).

Process Conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 172 MPa at which point steam was vented to maintain the pressure at 1.72 Mpa. The temperature of the contents was allowed to rise to 250° C. The pressure was then reduced to 0 psig over about 45 minutes. During this time, the temperature of the contents rose to 275° C. The autoclave pressure was reduced to 5 psia by applying vacuum and held there for 20 minutes. The autoclave was then pressurized with 65 psia nitrogen and the molten polymer was extruded into strands, quenched with cold water and cut into pellets.

The co-polyimide obtained had an inherent viscosity (IV) of 1.22 dl/g. The polymer had a melting point of 252° C., as measured by DSC.

The data listed in Tables 1 and 2 indicate that the tan delta peak value of the copolyamides of Examples 1-3 are less than 0.20, and all examples show tan delta peak values of less than 0.15; whereas the comparative examples of Table 2 comprising PA 66/610 copolymers all show tan delta peak value of greater than 0.15 and Comparative examples C-6 and C-7 show tan delta peak values of greater than 0.30. Lower tan delta peak values are indicative of higher crystallinity. Thus, the copolyamides of Examples 1-3 show higher crystallinity values than PA66/610 copolymers. Higher crystallinity leads to higher heat stability and burst pressure stability at higher temperature. PA610/66 shows much lower crystallinty compared to PA614/616 and PA616/618 copolymers,

TABLE 1
Thermal Properties of PA616/618 copolyamides and
PA616 and PA618 homopolyamides

| | Example | | | | |
|---|---|---|---|---|---|
| | C-1 | C-2 | 1 | 2 | 3 |
| Polymer Type | PA616 | PA618 | PA 616/618 | PA616/618 | PA616/618 |
| | | | 47/53 | 90/10 | 10/90 |

DSC data

| | | | | | |
|---|---|---|---|---|---|
| Melt Point (C.) | 207 | 192 | 185 | 204 | 191 |
| Heat of fusion (J/g) | 65 | 67 | 67 | 67 | 67 |
| Freeze Point (C.) | 180 | 164 | 165 | 179 | 169 |
| Delta T (MP-FP) (C.) | 27 | 28 | 20 | 26 | 22 |

DMA data

| | | | | | |
|---|---|---|---|---|---|
| Storage modulus at | 1473 | 1355 | 1356 | 1432 | 1317 |
| 23 C. (Mpa) | | | | | |
| Tan delta | 60 | 53 | 56 | 58 | 54 |
| Tan delta peak value | 0.11 | 0.12 | 0.13 | 0.11 | 0.12 |

TABLE 2
Thermal Properties of PA66 and PA610 homopolyamides versus PA66/610 copolyamides

| | Example | | | | | |
|---|---|---|---|---|---|---|
| | C-3 | C-4 | C-5 | C-6 | C-7 | C-8 |
| Polymer Type | PA66 | PA610 | PA610/66 | PA610/66 | PA610/66 | PA610/66 |
| | | | 90/10 | 60/40 | 50/50 | 10/90 |

DSC data

| | | | | | | |
|---|---|---|---|---|---|---|
| Melt Point (C.) | 263 | 224 | 216 | 194 | 200 | 252 |
| Heat of fusion (J/g) | 70 | 62 | 63 | 50 | 48 | 67 |
| Freeze Point (C.) | 233 | 188 | 179 | 128 | 142 | 208 |
| Delta T (MP − FP) | 30 | 36 | 37 | 66 | 58 | 44 |
| (C.) | | | | | | |

DMA data

| | | | | | | |
|---|---|---|---|---|---|---|
| Storage modulus at | 2263 | 1933 | 1816 | 1665 | 1688 | 2384 |
| 23 C. (Mpa) | | | | | | |
| Tan delta | 69 | 56 | 53 | 49 | 47 | 60 |
| Tan delta peak | 0.15 | 0.16 | 0.18 | 0.36 | 0.33 | 0.17 |
| value | | | | | | |

TABLE 3
Mechanicals and Salt test Summary Homo and Copolyamides

| | Example | | | | |
|---|---|---|---|---|---|
| | C-1 | C-2 | 1 | 2 | 3 |
| Polymer Type | PA616 | PA618 | PA616/618 | PA616/618 | PA616/618 |
| | | | 47/53 | 90/10 | 10/90 |

Physical testing

| | | | | | |
|---|---|---|---|---|---|
| Tensile Strength at 23 C. | 50 | 45 | 45 | 50 | 44 |
| (Mpa) (max load) | | | | | |
| Flex Modulus (Mpa) | 1781 | 1475 | 1514 | 1743 | 1477 |
| Tensile Modulus at 23 C. | 1697 | 1534 | 1473 | 1695 | 1468 |
| (Mpa) | | | | | |

Salt Stress Crack Resistance Test

| | | | | |
|---|---|---|---|---|
| Hours to failure at 50 C., | 191 | 191 + 24 | 191 | 191 + 24 |
| 50% ZnCl2 | | hours dry | | hours dry |
| solution | | out | | out |

We claim:

1. A copolyamide consisting essentially of 8 to 92 mole percent repeat units of the formula
—C(O)(CH₂)₁₄C(O)NH(CH₂)ₙNH— (I)
and 8 to 92 mole percent repeat units of the formula
—C(O)(CH₂)₁₆C(O)NH(CH₂)ₙNH— (II)
wherein n is an integer selected from 4, 6, 10 and 12.

2. The copolyamide of claim 1 having 8 to 50 mole percent repeat units of formula (I) and 50 to 92 repeat units of formula (II).

3. The copolyamide of claim 1 having 40 to 50 mole percent repeat units of formula (I) and 50 to 60 repeat units of formula (II).

4. The copolyamide of claim 1 having 8 to 12 mole percent repeat units of formula (I) and 92 to 88 repeat units of formula (II).

5. The copolyamide of claim 1 wherein n is 6.

6. The copolyamide of claim 1 having a carbon content, wherein the carbon content comprises at least 50 percent modern carbon as determined with ASTM-D6866 method.

7. The copolyamide of claim 1 wherein the repeat units (I) and (II) are prepared from C16 and C18 dioic acids derived from microbial oxidation of linear alkanes.

8. The copolyamide of claim 7 wherein the linear alkanes are derived from hydrotreating of vegetable oils selected from the group consisting of soybean oil, palm oil, sunflower oil, olive oil, cotton seed oil, peanut oil, castor oil, canola oil, and corn oil.

9. A thermoplastic composition comprising
A) a copolyamide consisting essentially of 8 to 92 mole percent repeat units of the formula
—C(O)(CH₂)₁₄C(O)NH(CH₂)ₙNH— (I)
and 8 to 92 mole percent repeat units of the formula
—C(O)(CH₂)₁₆C(O)NH(CH₂)ₙNH— (II)
wherein n is an integer selected from 4, 6, 10, and 12; and at least one component selected from the group consisting of:
B) 0 to 60 wt % of at least one reinforcing agent;
C) 0 to 30 wt % of at least one polymeric toughener;
D) 0 to 10 weight percent of a functional additive;
wherein the weight percent of A), B), C), and D) are based on the total weight of the thermoplastic composition, and at least one component of the group B), C) and D) is present in at least 0.1 weight percent.

10. The thermoplastic composition of claim 9 wherein said copolyamide has 8 to 92 mole percent repeat units of formula (I) and 8 to 92 repeat units of formula (II).

11. The thermoplastic composition of claim 9 wherein said copolyamide has 8 to 50 mole percent repeat units of formula (I) and 50 to 92 repeat units of formula (II)

12. The thermoplastic composition of claim 9 wherein said copolyamide has 40 to 50 mole percent repeat units of formula (I) and 50 to 60 repeat units of formula (II).

13. The thermoplastic composition of claim 8 wherein said copolyamide has 8 to 12 mole percent repeat units of formula (I) and 92 to 88 repeat units of formula (II).

14. The thermoplastic composition of claim 8 wherein said copolyamide has n equal 6.

15. The thermoplastic composition of claim 8 wherein said copolyamide repeat units (I) and (II) are prepared from C16 and C18 dioic acids derived from microbial oxidation of linear alkanes.

16. The thermoplastic composition of claim 15 wherein the linear alkanes are derived from hydrogenation of vegetable oils selected from the group consisting of soybean oil, palm oil, sunflower oil, olive oil, cotton seed oil, peanut oil, castor oil, canola oil, and corn oil.

17. A tubing comprising:
(A) a copolyamide consisting essentially of 8 to 92 mole percent repeat units of the formula
—C(O)(CH₂)₁₄C(O)NH(CH₂)ₙNH— (I); and
8 to 92 mole percent repeat units of the formula
—C(O)(CH₂)₁₆C(O)NH(CH₂)ₙNH— (II);
wherein n is an integer selected from 4, 6, 10 or 12;
(B) 0 to 30 weight percent of at least one polymeric toughener;
(D) 0 to 10 weight percent thermal stabilizer; and
(E) 0 to 20 weight percent of plasticizer; and
wherein the weight percent of (A), (B), and (D) and (E) are based on the total weight of the thermoplastic composition.

18. The use of a polyamide or copolyamide consisting essentially of repeat units selected from the group consisting of formulas
—C(O)(CH₂)₁₄C(O)NH(CH₂)ₙNH— (I);
—C(O)(CH₂)₁₆C(O)NH(CH₂)ₙNH— (II);
and mixtures of (I) and (II); wherein n is an integer selected from 4, 6, 10 and 12; to provide salt resistance in injection molded thermoplastic articles.
